(19) United States
(12) Patent Application Publication
(10) Pub. No.: US 2002/0038226 A1
(43) Pub. Date: Mar. 28, 2002

(54) System and method for capturing and archiving medical multimedia data

(76) Inventor: Cheryl M. Tyus, Evanston, IL (US)

Correspondence Address: Bullwinkle Partners, Ltd, 19 S. LaSalle St., Suite 1300, Chicago, IL, 60603, US

(21) Appl. No.: 09/963,694

(22) Filed: Sep. 26, 2001

Related U.S. Application Data
(60) Provisional application No. 60/235,437, filed on Sep. 26, 2000.

(51) Int. Cl. G06F 17/60

(52) U.S. Cl. 705/2

(57) ABSTRACT

A system and method for capturing and archiving medical images and accompanying data from various sources, and making the data available to users. The image data may be captured using scanners, digital cameras, digital cameras attached to microscopes, and/or other imaging equipment. Where possible, the system interfaces directly with manufacturers' imaging equipment via a communications port to capture the images and accompanying data. The system comprises a distributed database schema to integrate heterogeneous, multiple, encapsulated databases throughout the enterprise. The system uses computer and healthcare industry standards for hardware and software to reduce dependencies on closed-end proprietary medical systems, to enable integration among departments, and to provide a high degree of distribution transparency for users. Queries are based upon a user interface that invokes both parameterized options and parsing using elements of both relational algebra and relational calculus. The system displays domain knowledge in the appropriate manner for each medical specialty.

### BACKGROUND

1. Field of the Invention

This invention is in the field of capturing, archiving and distributing textual and multimedia data. The invention is method and system for capturing and archiving both medical images and their associated data. The associated data may be text, video, or audio data. The system software binds together the textual data supporting the images and other multimedia data. The system software may be used by various medical specialties.

2. Description of the Related Art

Images have become an essential part of medical diagnosis and treatment. For example, medical imaging can tell a neurosurgeon exactly where to make an incision to provide maximum effectiveness while minimizing damage to delicate structures. Currently medical images are usually kept in and/or by their respective medical departments. Thus, imaging from a lower GI procedure may be found in the gastroenterology lab, in a general medical records area, in the radiology department, in a patient's chart, or even in the custody of another physician for consultation. Consequently, medical images are frequently unavailable, either because they cannot be physically transferred from one location to another in a timely manner or because they are misfiled, damaged, in transit, or lost. The result can be incomplete information for diagnosis and treatment and the risk of spoliation for the institution.

Many times imaging procedures are repeated, thus incurring the concomitant costs and risks solely because the previous relevant image is unavailable. This problem is significant enough, especially when dealing with critical illnesses and injuries, to prompt a third party market for systems that store medical images on behalf of patients and physicians. However, most of these third party systems capture and store medical images only. What is needed is a universal enterprise-wide multimedia system for capturing, archiving and distributing medical images and their associated domain data. What is also needed is a system that maintains the audit trail for the image/audio/video data and provides reproducible results.

### BRIEF DESCRIPTION OF THE DRAWINGS

FIG. 1 is a schematic showing how the archival system (F) captures and distributes data among the enterprise system (D), remote access (A), and medical departments (E).

### SUMMARY OF THE INVENTION

The invention is a system for capturing, storing and transmitting images and associated contextual data from both radiology specialties and non-radiology imaging disciplines. Storing both the image and the associated data permits an institution to document an audit trail for the course of a disease or the treatment plan. The system can function as a document imaging system for related data, and the documents can be processed by commercial optical character recognition (OCR) software and searched from the system query module. The system is also useful for training purposes, clinical research, and basic research, and can serve as an institutional library or knowledgebase.

The system captures images and the accompanying domain data from various sources/departments and makes the data available to users. Image data may be captured using various data generating means, including digital cameras, digital cameras attached to microscopes, diagnostic devices with graphic output, and other medical imaging instruments.

The system can interface directly with the imaging instrument physically via a communications port, or the data may be accessed via a departmental or enterprise network. Pre-existing images that are available on the imaging instrument or on a computer system can be captured and archived along with any accompanying clinical data via the system software.

Images and video can also be captured using videoconferencing or a Telemedicine module/component. Telemedicine increases access to medical specialty services while decreasing health care costs. It provides improved public health, employment for lay community-based healthcare workers, and increases compliance especially in rural communities, corrections facilities, for seniors and others with impaired mobility.

The invention enhances the clinician's ability to provide quality medical care by providing support for integration of multimedia data with accompanying clinical/textual data. The system can provide the data necessary for Outcomes Research, Evidence-based Practice Centers sponsored by NIH through the Agency for Healthcare Research and Quality, and institutional Critical Path practice guidelines.

### DETAILED DESCRIPTION OF THE INVENTION

The present invention is a method and system for capturing and archiving medical images, video, audio and text into a database and making the data available to a user. The system comprises (1) means for generating image and textual data, (2) means for capturing the data, (3) means for storing the data in an archive, and (4) means for transmitting the data to a user. The system may also comprise means for querying numeric, character, logical, date and binary fields.

The means for generating the data includes means for generating both image and textual data, and includes digital cameras, video cameras, microscopes with attached digital cameras, x-ray machines, nuclear magnetic resonance units, other imaging instruments, scanners, voice recognition systems, pre-existing computer data files, keyboards and other computer input devices, and networks, modems and wireless communication equipment for sending data via the Internet, or any other suitable generating means.

Where the data generating means is voice recognition equipment, a system audio component enables the user to either bypass or enhance transcription services by storing data directly into the report. The audio data is immediately inputted into the report format and stored in the database. The stored voice data in report format may then be printed for normal reporting purposes, replayed for immediate verbal reporting purposes, or stored along with the data and images for the case.

The means for capturing the data comprises a software program and computer. The type of medical data that can be captured includes gross images, microscopic images, photographic images, digital images, printed images, still images, video images, radiology images, audio data, and other multimedia data and accompanying clinical data. The system can provide document imaging functions by interfacing with popular optical character recognition (OCR) software packages. Appropriate documents can be archived as images or searchable text-based data and may be captured by scanning or by accessing existing computer files. The audio component of the system enables the user to either bypass or enhance transcription services by storing data directly into the report. The audio data is immediately inputted into the report format and stored in the database. The stored voice data in report format may then be printed for normal reporting purposes, replayed for immediate verbal reporting purposes, or stored along with the data and images for the case.

The means for storing the data in an archive comprises industry-standard storage devices and media such as hard drives, floppy drives, removable storage systems, optical storage, CD drives, an array of drives, and networked drives internal to the organization or over the Internet.

The means for transmitting the data comprises a computer program and a suitable computer monitor or other display device.

The system is capable of being used on a single computer, as part of a local network of computers, as part of an enterprise network, or as part of a network that includes the World Wide Web.

Optionally, the system may include a telemedicine or videoconferencing component with the ability to provide healthcare services over distance utilizing a wired or wireless connection to a regional medical center or provider.

Types of Input

The system accommodates medical data in the form of radiology and non-radiology images, text, audio input, and video input, as well as other types of input.

The system stores radiology images in DICOM format. In the past, the term PACS usually referred solely to radiology gray-scale images, since radiology was the predominant user of images. The international industry standard for radiology images is DICOM. The current format for storing radiology images is Part 10. The UMMA system software interfaces with DICOM imaging equipment or a hospital/departmental interface engine to capture and store DICOM images.

The system can also store images in non-DICOM format. Technology has brought imaging to many other specialties and departments—some utilizing the DICOM imaging format (the radiology image standard) but most using non-DICOM imaging formats. One early application of the present invention is in the field of pathology. Other specialties and/or areas of interest include dermatology, endoscopy, cardiology, clinical trials, veterinary medicine, and forensics.

The system can be trained to recognize voice commands and voice input and translate the voice input into voice data. The system stores the voice data directly into a database, bypassing the usual word processing file. Preferably, the voice input is parsed into a database. The system can also record the voice data, archive it, and replay it as dictation.

The system is capable of accepting input from the Internet and other systems. Such data includes clinical video data, such as EKG tracings. The system also has a telemedicine component that displays live video via the web using both standard web access and wireless web access.

Data Storage

By storing both images and their associated data, the system permits an institution to document an audit trail for the course of a disease or condition, for treatment, and research purposes. This dual storage capability also enables the system to be used for training, clinical research and basic research, and can serve as an institutional library or knowledge base.

The system is based on international and industry standards

The system is based on international healthcare industry and computer industry standards. For example, in handling radiological data, the system supports/reads/writes DICOM Part 10 format files, the radiological industry standard. For non-radiology imaging, the system supports/reads/writes all non-vector graphic formats. Unless otherwise directed, the system saves image data in a format that does not degrade with time, usage, and compression. The system uses the HL-7 (Health Level 7) international standard mark-up language for communicating healthcare information to access hospital and departmental systems. The system also uses the more concise XML mark-up language standard to support/read/write XML data. The system runs on all industry standard Windows Operating Systems, including 95/98/ME/2000/NT. The system operates on computers using industry standard chipsets such as Pentium-based technology.

Method of capturing and archiving medical data

The system is used to capture, archive and distribute medical imaging data and its associated textual data. The method of capturing, archiving and distributing medical data comprises the steps of:

(a) Generating medical image and/or textual data (“medical data”) by one or more input devices;

(b) Capturing the medical data from the input devices;

(c) Storing the medical data in an archive; and

(d) Transmitting the medical data on demand to the user.

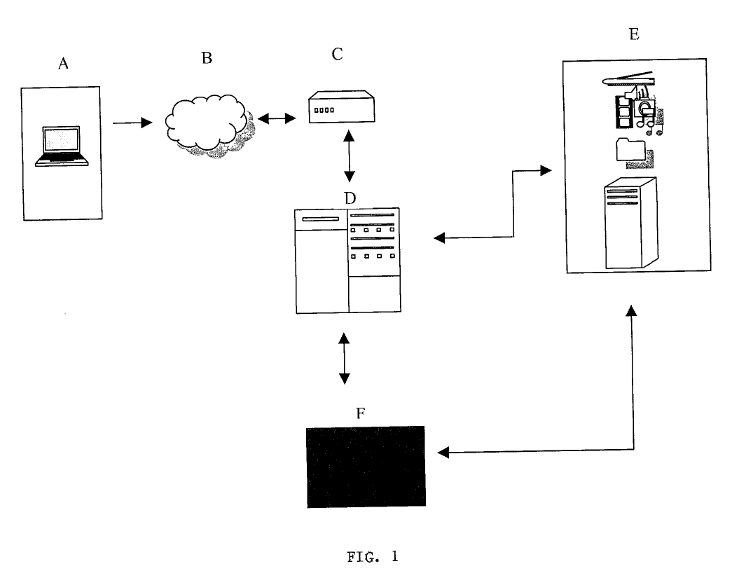

Thus there has been described a system and method for capturing and archiving medical imaging and associated textual data. FIG. 1 shows a schematic showing how the archival system (F) captures and distributes data among the enterprise system (D), remote access (A), and medical departments (E). The legend for FIG. 1 is as follows:

A—Remote access

B—Internet

C—Enterprise Firewall

D—Hospital Information System (HIS)

E—Domain information (Departments)

F—UMMA

The system comprises a distributed database schema to integrate heterogeneous, multiple, encapsulated databases throughout the enterprise. The system uses computer and healthcare industry standards for hardware and software to reduce dependencies on closed-end proprietary medical systems, to enable integration among departments, and to provide a high degree of distribution transparency for users. Queries are based upon a user interface that invokes both parameterized options and parsing using elements of both relational algebra and relational calculus. The system displays domain knowledge in the appropriate manner relative to its medical specialty.

The system can:

(a) Capture audio medical data through voice recognition software, store the data, retrieve it, and reproduce of the audio data;

(b) Capture, archive, retrieve, annotate, apply effects, and reproduce images, text, audio and video medical data;

(c) Capture still image data from cameras and/or cameras attached to microscopes and/or microscope/cameras and/or medical imaging equipment that produce still images;

(d) Capture video data images from video cameras and/or video cameras attached to microscopes and/or medical devices that display visual sequential data output;

(e) Capture audio data from a microphone and/or pre-existing audio data file;

(f) Store clinical data in a database with accompanying multimedia data;

(g) Control voice-directed audio data for entry into a database;

(h) Transmit data and images via TCP/IP over the Internet;

(i) Transmit data and images via Email over the Internet;

(j) Transmit data and images over the Internet via wireless communications protocols;

(k) Transmit data and images over the Internet via a wireless teleconferencing technology (telemedicine);

(l) Transmit data and images over the Internet via teleconferencing technology using a Virtual Private network (VPN);

(m) Search the archival database for data stored in a binary format;

(n) Search the archival database for data stored in a text format;

(o) Search the archival database for data stored in a numeric format;

(p) Maintain multi-level security;

(q) Display images associated with a case or study, individually or collectively;

(r) Annotate the images stored in the database;

(s) Export images in any graphic format including, but not limited to: tif, bmp, jpg, pcx, png, and gif;

(t) Produce reports including user-defined reports where the user selects a field from the list of all fields in the database and formats the report for display or printing;

(u) Calibrate microscopic images;

(v) Print images;

(w) Interface with presentation software to produce presentations from database selections;

(x) Convert graphic formats;

(y) Store images in a compressed or uncompressed format using a lossy or non-lossy compression algorithm; and

(z) Provide document imaging functions by interfacing with popular optical character recognition (OCR) software.

Other modifications and alternative embodiments of the invention are contemplated which do not depart from the scope of the invention as defined by the foregoing teachings and appended claims. It is intended that the claims cover all such modifications that fall within their scope.

I claim as my invention:

1. A system for capturing, archiving and transmitting medical images and their associated data, the system comprising:
(1) means for generating medical data, said medical data comprising both image data and textual data;
(2) means for capturing the medical data, said capturing means comprising a software program and computer;
(3) means for storing the data in an archive; and
(4) means for transmitting the data to a user.

2. The system of claim 1 further comprising means for querying numeric, character, logical, date and binary fields.

3. The system of claim 1 wherein the means for generating medical data comprises a voice recognition system and the medical data further comprises audio input.

4. The system of claim 3 further comprising a system audio component to enable a user to store the audio input directly into the archive in a report format.

5. The system of claim 1 wherein the storage means is selected from the group consisting of a hard drive, floppy drive, a removable storage system, an optical storage system, a CD drive, a networked drive internal to the user, an array of drives, and a networked drive accessible via the Internet.

6. The system of claim 1 further comprising a videoconferencing component to enable the user to provide healthcare services over distance utilizing a wired or wireless connection.

7. A method of capturing and archiving medical data comprising the steps of:
(a) generating medical data using one or more input devices, said medical data comprising both image and textual data;
(b) capturing the medical data from the input devices;
(c) storing the medical data in an archive that permits an institution to document an audit trail; and
(d) transmitting the medical data on demand to a user.

8. The method of claim 7 wherein the medical data comprises imaging data, textual data and audio data.
